(19) United States
(12) Patent Application Publication
(10) Pub. No.: US 2023/0286039 A1
(43) Pub. Date: Sep. 14, 2023

(54) DIE CASTING MACHINE AND AIRTIGHT INSPECTION METHOD

(71) Applicant: TOYOTA JIDOSHA KABUSHIKI KAISHA, Toyota-shi (JP)

(72) Inventor: Tomohiro KOYAMA, Toyota-shi (JP)

(73) Assignee: TOYOTA JIDOSHA KABUSHIKI KAISHA, Toyota-shi (JP)

(21) Appl. No.: 18/171,755

(22) Filed: Feb. 21, 2023

(30) Foreign Application Priority Data
Mar. 14, 2022 (JP) 2022-038800

(51) Int. Cl. B22D 17/32; G01M 3/32; G01M 3/34; B22D 17/04

(52) U.S. Cl. CPC B22D 17/32; G01M 3/3236; G01M 3/34; B22D 17/04

(57) ABSTRACT

The die casting machine includes: a sleeve with tubular shape, the sleeve communicating with inner space of a die casting mold; a plunger disposed in the sleeve, the plunger moving along a central axis of the sleeve; a sensor for measuring pressure of the inner space of the die casting mold; and a controller programmed to perform an airtight inspection of the die casting mold, during outside a molding period of a die casting product by the die casting machine; in the airtight inspection, wherein the controller is programmed to: pump gas in the sleeve to the inner space, or suck gas in the inner space into the sleeve, by moving the plunger in a clamping state, wherein the clamping state is a state of the die casting mold being clamped; obtain the pressure of the inner space from the sensor; determine an abnormality in airtightness of the die casting mold using measurement result of the pressure of the inner space.

### CROSS REFERENCE TO RELATED APPLICATIONS

This application claims priority to Japanese Patent Application No. 2022-038800, filed Mar. 14, 2022, the disclosure of which is incorporated by reference herein in its entirety.

### BACKGROUND

### Field

The present disclosure relates to a die casting machine and an airtight inspection method.

### Related Art

Patent Literature 1 discloses an apparatus for gas assisted injection molding in which a resin is molded by injecting a gas and a resin into a mold. The mold is provided with a supply port of a gas different from the supply port of the resin, the supply port of the gas is connected to the gas tank. The apparatus, during gas-assisted injection molding, using a pressure gauge provided between the supply port and the gas tank of the gas, to determine whether the gas is leaking from the mold.

Patent Literature 1: JP 2011-255541 A

In a die-casting machine for injecting molten metal supplied to an injection sleeve communicating with a mold by an injection plunger, the injection plunger is moved during molding of a die-cast product, it is preferable to inspect airtightness of the mold when the injection plunger is moved. However, the apparatus shown in Patent Literature 1, unlike the die casting machine, since the injection plunger is not provided, it is impossible to inspect the airtightness of the mold when the injection plunger is moved.

### SUMMARY

One aspect of the present disclosure provides a die casting machine. The die casting machine includes: a sleeve with tubular shape, the sleeve communicating with inner space of a die casting mold; a plunger disposed in the sleeve, the plunger moving along a central axis of the sleeve; a sensor for measuring pressure of the inner space of the die casting mold; and a controller programmed to perform an airtight inspection of the die casting mold, during outside a molding period of a die casting product by the die casting machine; in the airtight inspection, wherein the controller is programmed to: pump gas in the sleeve to the inner space, or suck gas in the inner space into the sleeve, by moving the plunger in a clamping state, wherein the clamping state is a state of the die casting mold being clamped; obtain the pressure of the inner space from the sensor; determine an abnormality in airtightness of the die casting mold using measurement result of the pressure of the inner space.

### BRIEF DESCRIPTION OF THE DRAWINGS

FIG. 1 is a schematic diagram showing a schematic configuration of the die casting machine in the first embodiment;

FIG. 2 is a flow chart showing the contents of the airtightness inspection process in the first embodiment;

FIG. 3 is a graph showing the relationship between the time and the pressure of the inner space of the mold in the airtight inspection;

FIG. 4 is a flow chart showing the contents of the airtightness inspection process in the second embodiment; and

FIG. 5 is a flow chart showing the contents of the airtightness inspection process in the third embodiment.

### DETAILED DESCRIPTION

### A. First Embodiment

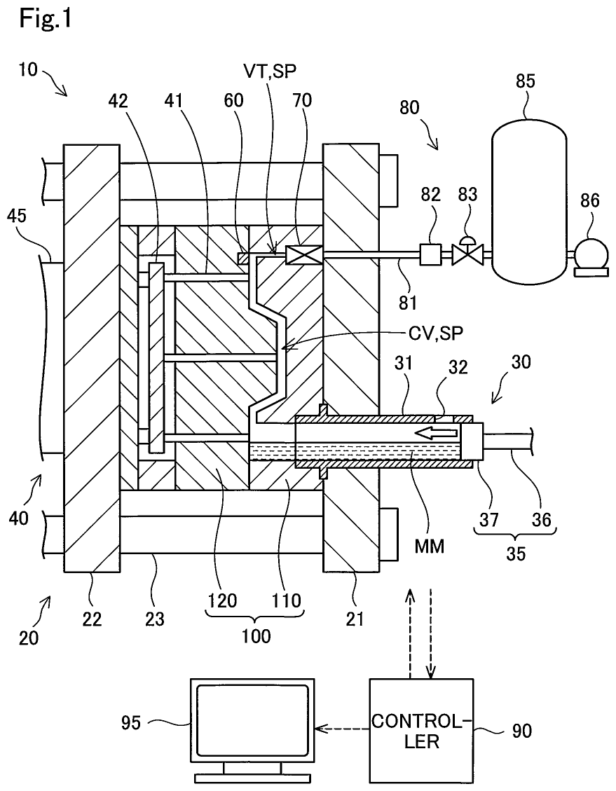

FIG. 1 is an explanatory view schematically showing a schematic configuration of a die casting machine 10 in the first embodiment. The die casting machine 10 includes a clamping device 20, an injection device 30, an extrusion device 40, a pressure sensor 60, an vent valve 70, a vacuum device 80, and a controller 90. The die casting machine 10, a mold 100 is mounted.

The clamping device 20 includes a fixed plate 21, a movable plate 22, a tie bar 23, and a drive unit (not shown). The tie bar 23 is a rod member. The fixed plate 21 is fixed to the distal end portion of the tie bar 23. The movable plate 22 is disposed so as to face the fixed plate 21. the movable plate 22 is moved along the tie bar 23 by the drive. The driving device of the clamping device 20 is constituted by, for example, a hydraulic cylinder and a toggle mechanism.

The clamping device 20, the mold 100 is mounted. The mold 100 includes a fixed mold 110, and a movable mold 120. The fixed mold 110 is mounted on the fixed plate 21. The movable mold 120 is mounted on the movable plate 22. Mold clamping device 20 executes the opening and closing of the mold 100 by moving the movable mold 120 together with the movable plate 22. Mold clamping device 20 executes the clamping of the mold 100 by pressing the movable mold 120 together with the movable plate 22 to the fixed mold 110. In FIG. 1, the mold 100 in a closed state by the clamping device 20 is represented. When the mold 100 is closed, a cavity CV is formed between the fixed mold 110 and the movable mold 120. Cavity CV, of the inner space SP of the mold 100 is a part having a shape corresponding to the shape of the die-cast product.

Injection device 30 includes an injection sleeve 31, an injection plunger 35, and a drive unit (not shown). The injection sleeve 31 is a cylindrical member. One end of the injection sleeve 31 is fixed to the fixed plate 21, and communicates with the cavity CV. From the other end of the injection sleeve 31, the injection plunger 35 is inserted into the injection sleeve 31. The portion between the one end and the other end of the injection sleeve 31, an inlet port 32 is provided.

The injection sleeve 31, through the inlet port 32, molten metal MM is poured is a material of die-cast products. The molten metal MM, for example, a molten aluminum alloy, or a molten zinc alloy, or a molten magnesium alloy, a molten copper alloy is used.

The injection plunger 35 comprises a plunger rod 36 and a plunger tip 37. Plunger rod 36 is a rod member. At one end of the plunger rod 36, a plunger tip 37 which fits into the injection sleeve 31 is fixed. The other end of the plunger rod 36 is coupled to a drive arranged outside the injection sleeve 31. Driving device of the injection device 30, for example, is constituted by a hydraulic cylinder.

The injection plunger 35 is moved along the central axis of the injection sleeve 31 by a drive. In the following description, the end of the fixed plate 21 side in the injection sleeve 31 is referred to as a front end. End opposite to the fixed plate 21 in the injection sleeve 31 is referred to as a rear end portion. The movement of the injection plunger 35 from the rear end of the injection sleeve 31 toward the front end is referred to as forward movement. The movement of the injection plunger 35 from the front end portion toward the rear end portion of the injection sleeve 31 is referred to as retraction. By advancing the injection plunger 35, the molten metal MM in the injection sleeve 31 is pumped to the cavity CV. The molten metal MM, by solidifying is cooled in the cavity CV, becomes a die-cast product.

Extrusion device 40 includes an extrusion pin 41, an extrusion plate 42, and a drive device 45. One end of the extrusion pin 41 is inserted into a through hole provided in the movable mold 120, the other end of the extrusion pin 41 is fixed to the extrusion plate 42 disposed between the movable mold 120 and the movable plate 22. The extrusion pin 41 and extrusion plate 42 are moved relative to the movable mold 120 by the drive device 45. Drive device 45, for example, is constituted by a hydraulic cylinder. The drive device 45, when the mold 100 is opened by the clamping device 20, by projecting the extrusion pin 41 toward the fixed mold 110 from the through hole of the movable mold 120, to release the die cast product from the movable mold 120.

Pressure sensor 60 is mounted on the mold 100. Pressure sensor 60 is used to measure the pressure of the inner space SP of the mold 100. In the present embodiment, the mold 100, in addition to the cavity CV described above, and has an air vent VT. Air vent VT, of the inner space SP of the mold 100, is a passage for discharging a gas such as air from the cavity CV to the outside of the mold 100. The air vent VT communicates with the injection sleeve 31 via a cavity CV. In the present embodiment, the pressure sensor 60 is provided at the end of the cavity CV air vent VT. The pressure of the inner space SP as measured by the pressure sensor 60 is expressed in gage pressure. The output signal from the pressure sensor 60 is transmitted to the controller 90. Note that the air vent VT is sometimes referred to as the evacuation passage. In other embodiments, the pressure sensor 60 may be provided at the cavity CV, for example, rather than at the end of the air vent VT. The pressure of the inner space SP as measured by the pressure sensor 60 may be expressed in terms of absolute pressure rather than gauge pressure.

Vent valve 70 is provided at an end of the air vent VT facing away from the cavity CV. Vent valve 70, for example, is constituted by a solenoid valve. Vent valve 70 is opened and closed under the control of the controller 90. Vent valve 70, a state in which the cavity CV and the vacuum device 80 to be described later is in communication switches between the state in which the communication between the cavity CV and the vacuum device 80 is cut off. More specifically, when the vent valve 70 is opened, the cavity CV and the vacuum device 80 are communicated with each other, and the vent valve 70 is closed, thereby blocking communication between the cavity CV and the vacuum device 80.

Vacuum device 80 includes a pipe 81, a filter 82, a vacuum valve 83, a vacuum tank 85, and a vacuum pump 86. One end of the pipe 81 is connected to the vent valve 70, the other end of the pipe 81 is connected to the vacuum tank 85 via the vacuum valve 83. Filter 82 is provided in the portion of the pipe 81 between the vent valve 70 and the vacuum valve 83. Filter 82 passes the gas, to collect foreign matter in the gas. Vacuum valve 83 is opened and closed under the control of the controller 90. The vacuum tank 85 is held in a vacuum by a vacuum pump 86. When the vent valve 70 and the vacuum valve 83 are opened, the gas of the cavity CV is sucked into the vacuum tank 85 and the cavity CV is depressurized.

The controller 90 is configured as a computer with a CPU, memories, and input/output interfaces. The controller 90 performs molding of the die cast product by controlling the clamping device 20, the injection device 30, the extrusion device 40, the vent valve 70 and the vacuum device 80. In the present embodiment, the controller 90, outside the molding period of the die-cast product, to execute the airtightness inspection to be described later. In the present embodiment, the controller 90, the Display 95 is connected. Display 95 is constituted by, for example, a liquid crystal display. The Display 95, the results of the airtightness inspection is displayed. The controller 90 is not a computer, it may be constituted by a combination of a plurality of circuits.

In the present embodiment, the die casting machine 10, a vacuum die-casting method, molding a die-cast product. Specifically, the controller 90 of the die casting machine 10, by controlling the clamping device 20, the mold 100 is closed, clamping the mold 100. The controller 90 then opens the vacuum valve 83 while the vent valve 70 remains closed. After the molten metal MM is supplied into the injection sleeve 31, the controller 90, by controlling the injection device 30, advances the injection plunger 35 to pump the molten metal MM in the injection sleeve 31 to the cavity CV. Controller 90 opens vent valve 70 at the timing of plunger tip 37 passing through inlet port 32 to evacuate the cavity CV gas to evacuation reservoir 85. The controller 90 closes the vent valve 70 and the vacuum valve 83 in this order at the timing when the advancement of the plunger tip 37 ends. Thus, while suppressing the molten metal MM flows into the pipe 81, it is possible to discharge the gas from the cavity CV. Controller 90, by waiting for a predetermined time, to solidify the molten metal MM injected into the cavity CV. Thereafter, the controller 90 opens the mold 100 by controlling the clamping device 20, the extrusion pin 41 by controlling the extrusion device 40 to protrude toward the fixed mold 110 from the through hole of the movable mold 120, the die cast product to release.

In the vacuum die casting method, when there is an abnormality in airtightness of the mold 100, when reducing the pressure of the cavity CV by the vacuum device 80, from the gap of the mold 100 (e.g., the gap between the fixed mold 110 and the movable mold 120, the gap between the movable mold 120 and the extrusion pin 41, or, the inner wall surface of the injection sleeve 31 and the plunger tip 37 gap), the air in the atmosphere flows into the cavity CV. The inflow amount of air from the gap between the inner wall surface and the plunger tip 37 of the injection sleeve 31 may be different at the time of movement and at the stop of the injection plunger 35. When air in the atmosphere flows into the cavity CV, it becomes difficult to depressurize the cavity CV to the target pressure. As a result, for example, molding defects such as blowholes in the die-cast product occurs, the quality of the die-cast product is sometimes lowered. Therefore, in the present embodiment, prior to the molding of the die-cast product, airtight inspection is performed on the mold 100.

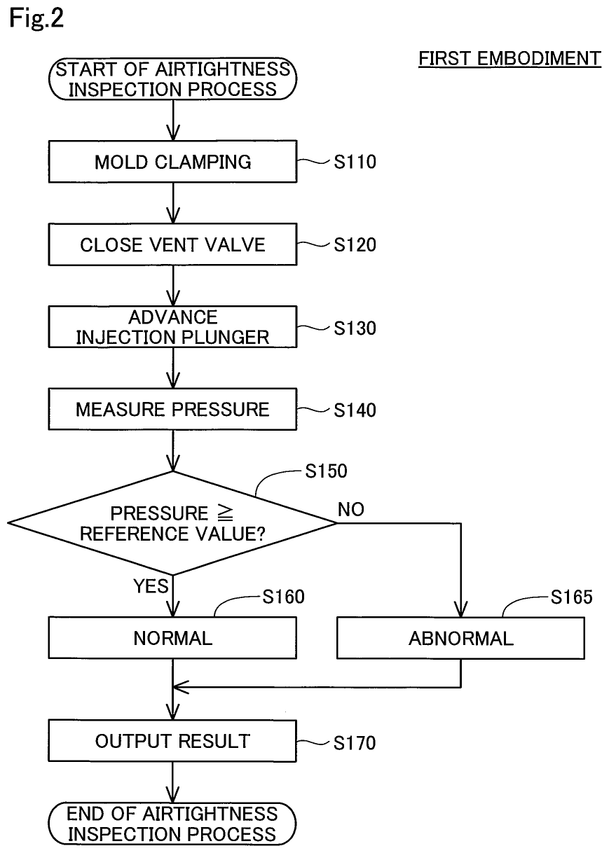

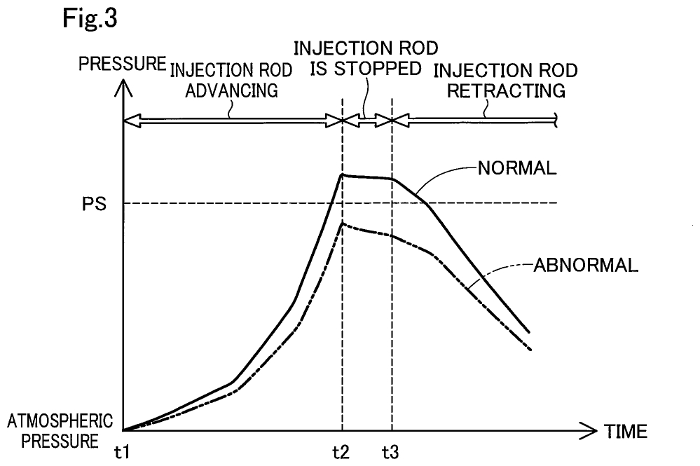

FIG. 2 is a flowchart showing the contents of the airtightness inspection process for executing the airtightness inspection in the present embodiment. FIG. 3 is a graph showing the relation between the pressure of the inner space SP of the time and the mold 100 in the airtightness test. In FIG. 3, the horizontal axis represents time, the vertical axis represents the pressure. In FIG. 3, the pressure when airtightness of the mold 100 is normal is represented by a solid line, the pressure when there is an abnormality in airtightness of the mold 100 is represented by a two-dot chain line. In FIG. 3, the pressure after the timing t1 the plunger tip 37 of the injection plunger 35 has passed through the inlet port 32 of the injection sleeve 31 is represented.

Airtight inspection process of the present embodiment shown in FIG. 2 is executed prior to the molding of the die-cast product by the die casting machine 10. Airtight inspection process, for example, when the start button provided in the die casting machine 10 is pressed, it is started by the controller 90. When the airtightness test process is started, first, in a step S110, the controller 90, by controlling the clamping device 20, executes the mold clamping of the mold 100. Next, in a step S120, the controller 90 closes the vent valve 70. The order of the step S110 and the step S120 may be reversed.

In a step S130, the controller 90 advances the injection plunger 35 by controlling the injection device 30. In the present embodiment, the controller 90 advances the injection plunger 35 so that the plunger tip 37 moves from near the rear end portion to near the front end portion of the injection sleeve 31. In the airtightness checking process, since the molten metal MM is not supplied into the injection sleeve 31, the advancing of the injection plunger 35, the air in the injection sleeve 31 is pumped to the inner space SP of the mold 100. The moving speed of the injection plunger 35 during the airtight inspection is preferably the same as the moving speed of the injection plunger 35 during molding of the die-cast product. In other embodiments, the controller 90 may advance the injection plunger 35 so that the plunger tip 37 moves from the position between the front end portion of the injection sleeve 31 and the inlet port 32 to the vicinity of the front end portion of the injection sleeve 31. The moving speed of the injection plunger 35 during the airtight inspection may be different from the moving speed of the injection plunger 35 during molding.

As shown in FIG. 3, prior to the advancing of the injection plunger 35 is started, the pressure of the inner space SP of the mold 100 is the same as the atmospheric pressure. When the advancing of the injection plunger 35 is started and the injection plunger 35 passes through the inlet port 32 of the injection sleeve 31 at the timing t1, the air is pumped from within the injection sleeve 31 to the inner space SP by advancing the injection plunger 35, the inner space SP is pressurized. Therefore, in the timing t2 immediately after the advance of the injection plunger 35 is completed, the pressure of the inner space SP is higher than the atmospheric pressure. When the abnormal airtightness of the mold 100 occurs, as compared with the case where the airtightness of the mold 100 is normal, the pressure of the inner space SP in the timing t2 is lowered. After advancing of the injection plunger 35 is completed, since the air of the inner space SP from the gap of the mold 100 flows out gradually, the pressure of the inner space SP in the timing t2 after the timing t2 is slightly lower than the pressure of the inner space SP in the timing t3. Thereafter, the pressure of the inner space SP is greatly reduced by retraction of the injection plunger 35 or by opening the vent valve 70.

As shown in FIG. 2, after the timing when the forward of the injection plunger 35 is completed, in a step S140, the controller 90 measures the pressure of the inner space SP under pressure by the pressure sensor 60. In the present embodiment, the controller 90 measures the pressure of the inner space SP in the timing t2 immediately after the forward end of the injection plunger 35 shown in FIG. 3. In other embodiments, the controller 90 is not a timing t2, for example, may measure the pressure of the inner space SP at a predetermined timing between the timing t2 and the timing t3. Note that prior to the step S140, the injection plunger 35 is not retracted, the vent valve 70 is not opened, the mold 100 is not opened.

In a step S150, the controller 90 determines whether the pressure measured by the pressure sensor 60 is equal to or greater than a predetermined reference value PS. If the pressure measured by the pressure sensor 60 is determined to be equal to or greater than the reference value PS, the controller 90, at a step S160, it is determined that the airtightness of the mold 100 is normal. On the other hand, if the pressure measured by the pressure sensor 60 is determined to be less than the reference value PS, the controller 90, at a step S165, determines that abnormal in airtightness of the mold 100 occurs. The reference value PS is determined, for example, based on the outcome of a test performed in advance. Specifically, by providing a plurality of different molds 100 of airtightness, in the same manner as the airtightness test process, pressurizing the inner space SP of each mold 100, the pressure sensor 60 provided in each mold 100, the timing t2 to measure the pressure of the inner space SP of each mold 100. Thereafter, molding the die-cast product using each mold 100. Of the measured pressure in the mold 100, the measured pressure in the mold 100 which does not occur abnormal die-cast products, it is possible to use as the reference value PS. The reference value PS may be determined based on, for example, simulated rather than the tests described above.

After the step S160 or the step S165, at a step S170, the controller 90 outputs a determination result for airtightness of the mold 100. In the present embodiment, the controller 90 displays the determination result of the airtightness of the mold 100 on the Display 95. Thereafter, the controller 90 ends the process. Note that the method performed by the airtightness inspection process is sometimes referred to as airtightness inspection method.

According to the die casting machine 10 in the present embodiment described above, the controller 90, in the airtightness test process described above, by advancing the injection plunger 35, pressurizes the inner space SP of the mold 100, based on the pressure of the inner space SP in a pressurized condition, to determine the presence or absence of an abnormal airtightness of the mold 100. Therefore, as compared with the form to inspect the airtightness of the mold 100 without moving the injection plunger 35, in a state close to the state at the time of molding of the die-cast product, it is possible to inspect the airtightness of the mold 100. Therefore, it can be effectively suppressed that abnormality occurs in the quality of the die-cast product. In particular, in the present embodiment, without providing a compressor or a gas tank for pressurizing the inner space SP of the mold 100, by pressurizing the inner space SP by advancing the injection plunger 35 provided in the die casting machine 10, the mold 100 it is possible to inspect the airtightness. Therefore, with a simple configuration, it is possible to inspect the airtightness of the mold 100.

Further, in the present embodiment, the controller 90, in the airtightness test process, after closing the vent valve 70 provided in the mold 100, so advancing the injection plunger 35, the inner space SP of the mold 100 by advancing the injection plunger 35 it can be effectively pressurized. Therefore, it is possible to increase the accuracy of the airtightness inspection.

Further, in the present embodiment, the controller 90, when the pressure of the inner space SP of the mold 100 measured at a predetermined timing after the advancing of the injection plunger 35 is completed is less than a predetermined reference value, the mold 100 it is determined that an abnormality has occurred in the airtightness. Therefore, it is possible to determine the presence or absence of abnormality airtightness of the mold 100 by a simple method.

Further, in the present embodiment, the controller 90, after performing the airtightness test process, while reducing the pressure of the cavity CV of the mold 100 by the vacuum device 80, the injection plunger 35 the molten metal MM supplied to the injection sleeve 31 by pumping to the cavity CV, to mold the die-cast product. Therefore, the air in the atmosphere flows into the cavity CV when the pressure of the cavity CV by the vacuum device 80, it is possible to suppress the quality of the die-cast product is lowered.

### B. Second Embodiment

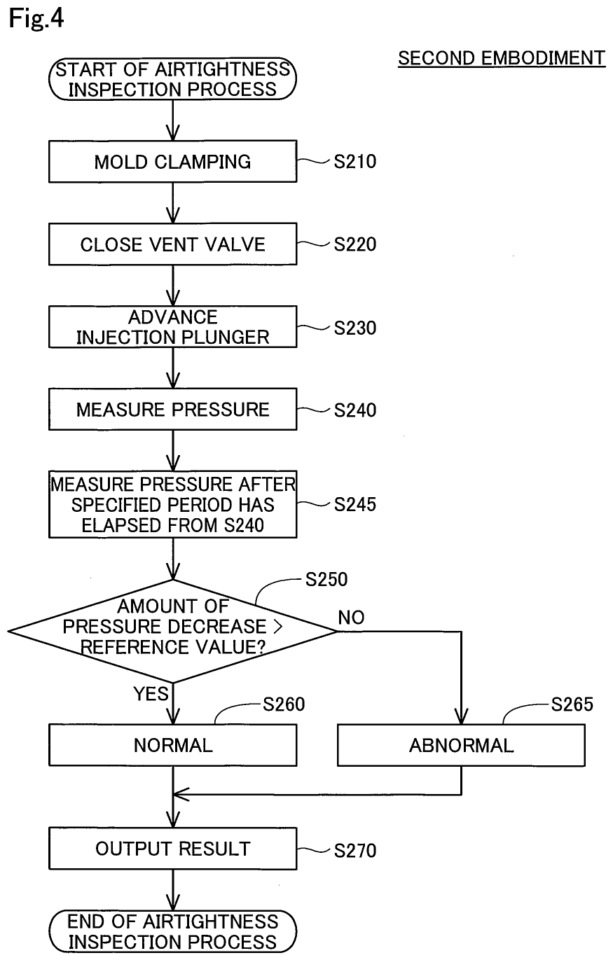

FIG. 4 is a flowchart showing the contents of the airtightness inspection process executed in the die casting machine 10 of the second embodiment. In the second embodiment, in the airtight inspection process, the controller 90 of the die casting machine 10, instead of determining the presence or absence of abnormality of the mold 100 based on the pressure of the inner space SP of the mold 100 measured at a predetermined timing after the advance of the injection plunger 35 is completed, the pressure of the inner space SP measured at a predetermined timing after the advance of the injection plunger 35 is completed, and the pressure measured at a subsequent timing, based on the absolute value of the difference, it is different from the first embodiment to determine the presence or absence of abnormality of the mold 100. For other configurations, unless otherwise described, it is the same as the first embodiment.

In the present embodiment, when the airtightness test process is started, in a step S210, the controller 90 executes the clamping of the mold 100. In a step S220, the controller 90 closes the vent valve 70. In a step S230, the controller 90 pressurizes the inner space SP of the mold 100 by advancing the injection plunger 35. In a step S240, the controller 90, at a predetermined timing after the advancing of the injection plunger 35 is completed, the pressure of the inner space SP of the mold 100 in a pressurized condition, measured by the pressure sensor 60.

In a step S245, the controller 90, the pressure of the inner space SP after a lapse of a predetermined time from the timing of the step S240, is measured by the pressure sensor 60. More specifically, the controller 90, at the step S240, measures the pressure of the inner space SP in the timing t2 (see FIG. 3), at the step S245, the inner space SP in the timing t3 (see FIG. 3) to measure the pressure. Note that prior to the step S245, the injection plunger 35 is not retracted, the vent valve 70 is not opened, the mold 100 is not opened. The timing of measuring the pressure of the inner space SP by the process of the step S240 is referred to as the first timing, the timing of measuring the pressure of the inner space SP by the process of the step S245 is sometimes referred to as the second timing.

In a step S250 steps, the controller 90, the pressure of the inner space SP measured by the timing t2, the absolute value of the difference between the pressure of the inner space SP measured by the timing t3, determines whether less than a predetermined reference value. In other words, the controller 90 determines whether the amount of decrease in the pressure of the inner space SP in a predetermined time period after the forward of the injection plunger 35 is completed is less than a predetermined reference value. For example, the reference value may be determined based on pre-performed tests or simulation results. If the amount of decrease in the pressure of the inner space SP in a predetermined time period after the advance of the injection plunger 35 is completed is determined to be less than the reference value, the controller 90, at a step S260, the airtightness of the mold 100 is normal It is determined to be. On the other hand, if the amount of decrease in the pressure of the inner space SP in a predetermined time period after the forward of the injection plunger 35 is completed is determined to be equal to or greater than the above reference value, the controller 90, at a step S265, the mold 100 it is determined that an abnormal airtightness has occurred. After the step S260 or the step S265, in a step S270, the controller 90 displays the determination for airtightness of the mold 100 on the Display 95. Thereafter, the controller 90 ends the process.

According to the die casting machine 10 in the present embodiment described above, the controller 90, in the airtightness inspection process, the decrease amount of the pressure of the inner space SP in a predetermined time period after the advancing of the injection plunger 35 is completed by comparing the predetermined reference value, to determine the presence or absence of abnormalities in airtightness of the mold 100. As shown in FIG. 3, when the abnormal airtightness of the mold 100 occurs, as compared with the case where the airtightness of the mold 100 is normal, since the air flows out easily to the outside of the mold 100 from the inner space SP, the inner space SP during the above period the reduction of the pressure is increased. Therefore, by comparing the decrease in pressure of the inner space SP during the above period to the reference value, it can accurately determine the presence or absence of abnormalities in airtightness of the mold 100.

### C. Third Embodiment

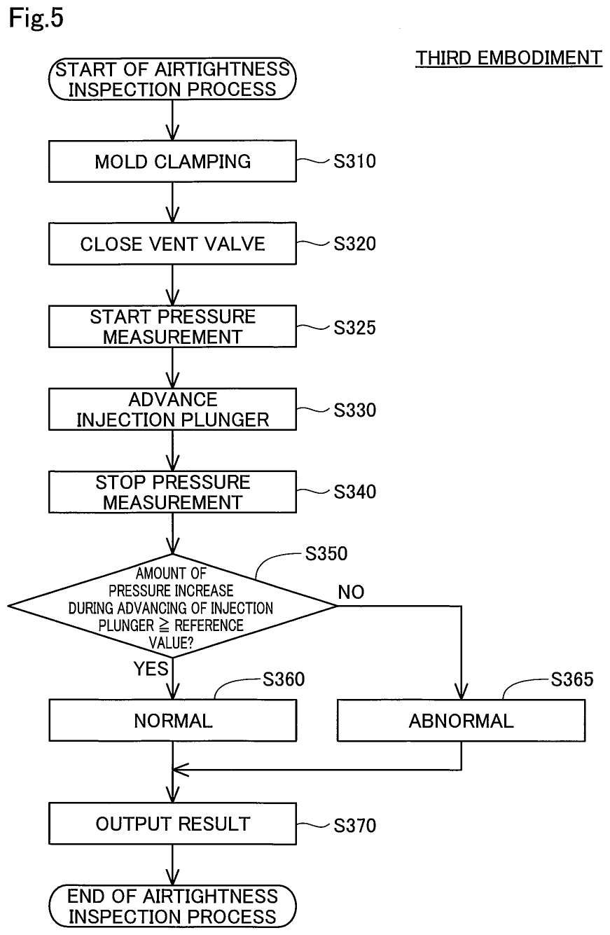

FIG. 5 is a flowchart showing the contents of the airtightness inspection process executed in the die casting machine 10 of the third embodiment. In the third embodiment, the airtightness inspection process, the controller 90 of the die casting machine 10, rather than determining the presence or absence of abnormality of the mold 100 based on the pressure of the inner space SP of the mold 100 at a predetermined timing after the advancing of the injection plunger 35 is completed, the injection plunger 35 It differs from the first embodiment to determine the presence or absence of abnormality of the mold 100 based on the absolute value of the rate of change of the pressure of the inner space SP during the period of advancing. For other configurations, unless otherwise described, it is the same as the first embodiment. Incidentally, the pressure is expressed as a function of time as a variable, the rate of change of the pressure means that the differential coefficient of the pressure. In the following description, the rate of change of the pressure when the pressure is increasing is referred to as the rate of increase of the pressure, the rate of change of the pressure when the pressure is decreasing referred to as the rate of decrease of the pressure.

In the present embodiment, when the airtightness test process is started, in a step S310, the controller 90 executes the clamping of the mold 100. In a step S320, the controller 90 closes the vent valve 70. In a step S325, the controller 90 begins measuring the pressure of the inner space SP by the pressure sensor 60. After the pressure measurement is started, in a step S330, the controller 90 pressurizes the inner space SP of the mold 100 by advancing the injection plunger 35. After the advancing of the injection plunger 35 is completed, in a step S340, the controller 90 terminates the measurement of the pressure of the inner space SP by the pressure sensor 60. Note that prior to the step S340, the injection plunger 35 is not retracted, the vent valve 70 is not opened, the mold 100 is not opened.

In a step S350, the controller 90, among the period of advancing the injection plunger 35, the increase rate of the pressure of the inner space SP in the period after the plunger tip 37 of the injection plunger 35 has passed through the inlet port 32 of the injection sleeve 31 is determined whether or not a predetermined reference value or more. That is, the controller 90 determines whether the increasing rate of the pressure of the inner space SP in a period later than the timing t1 (see FIG. 3) is equal to or greater than a predetermined reference value. For example, the reference value may be determined based on pre-performed tests or simulation results. If the increasing rate of the pressure of the inner space SP in the period after the timing t1 is determined to be equal to or greater than the reference value, the controller 90, at a step S360, the airtightness of the mold 100 is determined to be normal. On the other hand, if the increasing rate of the pressure of the inner space SP in the period later than the timing t1 is determined to be less than the reference value, the controller 90, at a step S365, the mold 100 it is determined that an abnormal airtightness occurs. After the step S360 or the step S365, in a step S370, the controller 90 displays the determination for airtightness of the mold 100 on the Display 95. Thereafter, the controller 90 ends the process.

According to the die casting machine 10 in the present embodiment described above, the controller 90, in the airtightness inspection process, by comparing the increasing rate of the pressure of the inner space SP during the period of advancing the injection plunger 35 with a predetermined reference value, the mold 100 to determine whether there is an abnormal airtightness. As shown in FIG. 3, when the abnormal airtightness of the mold 100 occurs, as compared with the case where the airtightness of the mold 100 is normal, since the air flows out easily to the outside of the mold 100 from the inner space SP, the inner space SP in the above period the increasing rate of the pressure is reduced. Therefore, by comparing the increasing rate of the pressure of the inner space SP in the above period and the reference value, it can accurately determine the presence or absence of abnormalities in airtightness of the mold 100. Furthermore, in the present embodiment, the controller 90, rather than the pressure of the inner space SP at a predetermined timing after the advance of the injection plunger 35 has been completed, based on the increasing rate of the pressure of the inner space SP during the period of advancing the injection plunger 35 to determine the presence or absence of an abnormality in airtightness of the mold 100 based on, it is possible to early determine whether or not an abnormality has occurred in airtightness of the mold 100.

### D. Other Embodiments

(D1) In the first embodiment described above, the controller 90, in the airtightness inspection process, pressurizes the inner space SP of the mold 100 by advancing the injection plunger 35, the pressure of the inner space SP measured at a predetermined timing after the advancing of the injection plunger 35 is completed is less than a predetermined reference value when, it is determined that an abnormal airtightness of the mold 100 has occurred. In contrast, the controller 90, in the airtightness inspection process of the first embodiment, the inner space SP of the mold 100 by retracting the injection plunger 35 to a position between the front end portion and the inlet port 32 from the vicinity of the front end of the injection sleeve 31 it may be reduced. In this case, the controller 90, at a predetermined timing after the retraction of the injection plunger 35 is completed, the pressure of the inner space SP of the mold 100 in a state of being depressurized, measured by the pressure sensor 60. When the measured pressure of the inner space SP is equal to or greater than a predetermined reference value, the controller 90 determines that the abnormal airtightness of the mold 100 has occurred. When retracting the injection plunger 35 to a position between the front end portion and the inlet port 32 from the position near the front end of the injection sleeve 31, the pressure of the inner space SP of the mold 100 in the airtightness test process, the waveform shown in FIG. 3 since the vertical opposite to the waveform, by the methods described above, it is possible to determine the presence or absence of an abnormal airtightness of the mold 100. Incidentally, prior to the pressure of the inner space SP is measured, the injection plunger 35 does not advance, the vent valve 70 is not opened, the mold 100 is not opened.

(D2) In the second embodiment described above, the controller 90, in the airtightness inspection process, pressurizes the inner space SP of the mold 100 by advancing the injection plunger 35, the decrease in the pressure of the inner space SP in a predetermined time period after the advancing of the injection plunger 35 is completed is equal to or greater than a predetermined reference value when, it is determined that an abnormal airtightness of the mold 100 has occurred. In contrast, the controller 90, in the airtightness inspection process of the second embodiment, by retracting the injection plunger 35 from the front end near the injection sleeve 31 to a position between the front end portion and the inlet port 32, the pressure lower than the atmospheric pressure the inner space SP of the mold 100 may be depressurized. In this case, the controller 90, when the increase in the pressure of the inner space SP in a predetermined time period after the retraction of the injection plunger 35 is completed is equal to or greater than a predetermined reference value, the mold 100 airtightness determines that an abnormality has occurred. If the abnormality in the airtightness of the mold 100 occurs, since the inflow amount of air in the atmosphere to the inner space SP of the mold 100 is increased, the increased amount of pressure of the inner space SP in the above period increases. Therefore, by the method described above, it is possible to determine the presence or absence of abnormality airtightness of the mold 100. Incidentally, prior to the pressure of the inner space SP is measured, the injection plunger 35 does not advance, the vent valve 70 is not opened, the mold 100 is not opened.

(D3) In the third embodiment described above, the controller 90, in the airtightness inspection process, pressurizes the inner space SP of the mold 100 by advancing the injection plunger 35, when the increasing rate of the pressure of the inner space SP during the period of advancing the injection plunger 35 is less than a predetermined reference value, it is determined that an abnormal airtightness of the mold 100 has occurred. In contrast, the controller 90, in the airtightness test process of the third embodiment, the inner space SP of the mold 100 by retracting the injection plunger 35 to a position between the front end portion and the inlet port 32 from the vicinity of the front end of the injection sleeve 31 it may be reduced. In this case, the controller 90, when the rate of decrease in the pressure of the inner space SP in the period while retracting the injection plunger 35 is less than a predetermined reference value, it is determined that an abnormality has occurred in the airtightness of the mold 100. When abnormality in the airtightness of the mold 100 occurs, since the inflow rate of air in the atmosphere to the inner space SP of the mold 100 is increased, the rate of decrease in the pressure of the inner space SP during retraction of the injection plunger 35 is reduced. Therefore, by the method described above, it is possible to determine the presence or absence of abnormality airtightness of the mold 100. Incidentally, prior to the pressure of the inner space SP is measured, the injection plunger 35 does not advance, the vent valve 70 is not opened, the mold 100 is not opened.

(D4) In each of the embodiments described above, the die casting machine 10 is provided with a vacuum device 80, by a vacuum die-casting method, molding a die-cast product. In contrast, the die casting machine 10 may not include a vacuum device 80. Even in this case, by a conventional die casting method, it is possible to mold the die-cast product. Incidentally, even when molding a die-cast product by a common die-casting method, when there is an abnormal airtightness of the mold 100, for example, since the molten metal MM is likely to enter the gap between the fixed mold 110 and the movable mold 120, the die-cast product burrs tend to occur. Therefore, by performing the airtightness inspection process, by detecting an abnormality in airtightness of the mold 100, it is possible to enhance the quality of the die-cast product.

(D5) The controller 90 of the die casting machine 10 may determine whether or not there is an abnormality in the airtightness of the mold 100 using the learned model learned by the machine learning. The learned model can be generated, for example, using a learning data set that includes a waveform of pressure measured by the pressure sensor 60 in the airtightness inspection described above and a label representing the presence or absence of an abnormality in airtightness of the mold 100. The learned model is configured to output a determination result of the presence or absence of abnormality of the airtightness of the mold 100 when the waveform of the pressure measured by the pressure sensor 60 is input.

(D6) In the above-described embodiments, the air vent VT of the mold 100, the vent valve 70 is provided. In contrast, the air vent VT of the mold 100 may be provided with a slit vent or a tilt vent instead of the vent valve 70. The slit vent is a member having a plurality of elongated slit holes. The slit vent passes the gas without passing through the molten metal MM. The tilt vent is a member with a serpentine, elongated passage. The tilt vent passes the gas without passing through the molten metal MM. If a slit vent or tilt vent is provided rather than the vent valve 70, the mold 100 is preferably configured so that the gas at the cavity CV is easily discharged to the outside of the mold 100 via a slit vent or air vent passageway, in order to enhance the quality of the die cast product. However, the molten metal MM within the passage of the slit vent or air vent is solidified, the gas of the cavity CV may be less likely to be discharged to the outside of the mold 100. Therefore, when the slit vent or tilt vent rather than the vent valve 70 is provided, the controller 90, in the airtightness inspection process, the determination of whether it is normal for airtightness of the mold 100, the vent valve 70 is provided it may be different from the determination in the case. For example, when the slit vent or tilt vent rather than the vent valve 70 is provided in the first embodiment, the controller 90, in the step S160 shown in FIG. 2, it is determined that an abnormal airtightness of the mold 100 has occurred, at the step S165, the airtightness of the mold 100 may be determined to be normal. Since the slit vent or tilt vent does not perform the opening and closing operation, when the slit vent or tilt vent rather than the vent valve 70 is provided, the controller 90, in the airtightness testing process, for example, as the step S120 shown in FIG. 2, the vent valve 70 it may not be executed a process corresponding to closing.

The disclosure is not limited to any of the embodiment and its modifications described above but may be implemented by a diversity of configurations without departing from the scope of the disclosure. For example, the technical features of any of the above embodiments and their modifications may be replaced or combined appropriately, in order to solve part or all of the problems described above or in order to achieve part or all of the advantageous effects described above. Any of the technical features may be omitted appropriately unless the technical feature is described as essential in the description hereof. The present disclosure may be implemented by aspects described below.

(1) According to a first aspect of the present disclosure, a die casting machine is provided. The die casting machine includes: a sleeve with tubular shape, the sleeve communicating with inner space of a die casting mold; a plunger disposed in the sleeve, the plunger moving along a central axis of the sleeve; a sensor for measuring pressure of the inner space of the die casting mold; and a controller programmed to perform an airtight inspection of the die casting mold, during outside a molding period of a die casting product by the die casting machine; in the airtight inspection, wherein the controller is programmed to: pump gas in the sleeve to the inner space, or suck gas in the inner space into the sleeve, by moving the plunger in a clamping state, wherein the clamping state is a state of the die casting mold being clamped; obtain the pressure of the inner space from the sensor; determine an abnormality in airtightness of the die casting mold using measurement result of the pressure of the inner space.

According to the die casting machine of this form, the controller, in the airtightness inspection, by moving the plunger, sucks the gas into the inner space of the die casting mold or the gas from the inner space, the pressure of the inner space reduced by the suction or pressure of the gas by the pressure feed of the gas to determine the presence or absence of abnormalities in airtightness of the die casting mold. Therefore, it is possible to inspect the airtightness of the die casting mold when the plunger is moved.

(2) According to the die casting machine of the above aspect, the die casting mold may have an exhaust flow path for discharging gas in the inner space to outside of the die casting mold, the die casting machine may include an exhaust valve disposed in the exhaust flow path, wherein the exhaust valve switches a communicating state and a non-communicating state, wherein the communicating state is a state of the inner space being communicating with the outside of the die casting mold, wherein the non-communicating is a state of the inner space being not communicating with the outside of the die casting mold, the controller may be programmed to pump the gas in the sleeve to the inner space in the non-communicating state.

According to the die casting machine of this form, the controller performs an airtight inspection with the exhaust valve closed, by the movement of the plunger, it is possible to effectively pressurize or depressurize the inner space of the die casting mold. Therefore, it is possible to increase the accuracy of the airtightness inspection.

(3) According to the die casting machine of the above aspect, the exhaust flow path may communicate a vacuum device for depressurized the inner space, the controller may be programmed to mold the die-cast product by pumping molten metal supplied into the sleeve to the inner space by the plunger, while depressurizing the inner space by the vacuum device.

According to the die casting machine of this form, by performing the airtight inspection prior to the molding of the die casting products, the air in the atmosphere into the internal space of the die casting mold when the internal space of the die casting mold is decompressed by the vacuum device. It can be suppressed to flow.

(4) According to the die casting machine of the above aspect, the controller may be programmed to determine the abnormality had occurred when the pressure measured by the sensor after the end of the movement of the plunger is less than a predetermined reference value.

According to the die casting machine of this form, the controller can determine the presence or absence of abnormality airtightness of the die casting mold by a simple method.

(5) According to the die casting machine of the above aspect, the controller may be programmed to determine the abnormality had occurred, when absolute value of difference between the pressure measured by the sensor at a first timing and the pressure measured by the sensor at a second timing is equal to or greater than a predetermined reference value, wherein the first timing is a timing after the end of the movement of the plunger, wherein the second timing is a timing after the first timing.

According to the die casting machine of this form, the controller can accurately determine the presence or absence of abnormality airtightness of the die casting mold.

(6) According to the die casting machine of the above aspect, the controller may be programmed to determine the abnormality had occurred, when absolute value of rate of change with respect to time of the pressure measured by the sensor during the movement of the plunger is less than a predetermined reference value.

According to the die casting machine of this form, the controller, since it is possible to determine the presence or absence of abnormality in airtightness of the die casting mold by using the pressure measured during the movement of the plunger, it is possible to shorten the airtightness inspection.

(7) According to a second aspect of the present disclosure, an airtight inspection method is provided. The airtight inspection method includes: pumping gas in a sleeve to inner space of a die casting mold, or sucking gas in the inner space into the sleeve, by moving a plunger in the sleeve in a clamping state, wherein the clamping state is a state of the die casting mold being clamped; measuring the pressure of the inner space, after the end of the movement of the plunger; determining an abnormality in airtightness of the die casting mold using measurement result of the pressure of the inner space.

According to the airtight inspection method of this form, by moving the plunger, the gas to the inner space of the die casting mold pumping or sucking gas from the inner space, the pressure of the inner space depressurized by the suction of pressurized or gas by the pumping of gas using, to determine the presence or absence of abnormalities in airtightness of the die casting mold. Therefore, it is possible to inspect the airtightness of the die casting mold when the plunger is moved.

What is claimed is:

1. A die casting machine comprising:
a sleeve with tubular shape, the sleeve communicating with inner space of a die casting mold;
a plunger disposed in the sleeve, the plunger moving along a central axis of the sleeve;
a sensor for measuring pressure of the inner space of the die casting mold; and
a controller programmed to perform an airtight inspection of the die casting mold, during outside a molding period of a die casting product by the die casting machine;
in the airtight inspection, wherein the controller is programmed to:
pump gas in the sleeve to the inner space, or suck gas in the inner space into the sleeve, by moving the plunger in a clamping state, wherein the clamping state is a state of the die casting mold being clamped;
obtain the pressure of the inner space from the sensor;
determine an abnormality in airtightness of the die casting mold using measurement result of the pressure of the inner space.

2. The die casting machine according to claim 1, wherein
the die casting mold has an exhaust flow path for discharging gas in the inner space to outside of the die casting mold,
the die casting machine includes an exhaust valve disposed in the exhaust flow path, wherein the exhaust valve switches a communicating state and a non-communicating state, wherein the communicating state is a state of the inner space being communicating with the outside of the die casting mold, wherein the non-communicating is a state of the inner space being not communicating with the outside of the die casting mold,
the controller is programmed to pump the gas in the sleeve to the inner space in the non-communicating state.

3. The die casting machine according to claim 2, wherein
the exhaust flow path communicates a vacuum device for depressurized the inner space,
the controller is programmed to mold the die-cast product by pumping molten metal supplied into the sleeve to the inner space by the plunger, while depressurizing the inner space by the vacuum device.

4. The die casting machine according to claim 1, wherein
the controller is programmed to determine the abnormality had occurred when the pressure measured by the sensor after the end of the movement of the plunger is less than a predetermined reference value.

5. The die casting machine according to claim 1, wherein
the controller is programmed to determine the abnormality had occurred, when absolute value of difference between the pressure measured by the sensor at a first timing and the pressure measured by the sensor at a second timing is equal to or greater than a predetermined reference value, wherein the first timing is a timing after the end of the movement of the plunger, wherein the second timing is a timing after the first timing.

6. The die casting machine according to claim 1, wherein
the controller is programmed to determine the abnormality had occurred, when absolute value of rate of change with respect to time of the pressure measured by the sensor during the movement of the plunger is less than a predetermined reference value.

7. An airtight inspection method comprising:
pumping gas in a sleeve to inner space of a die casting mold, or sucking gas in the inner space into the sleeve, by moving a plunger in the sleeve in a clamping state, wherein the clamping state is a state of the die casting mold being clamped;
measuring the pressure of the inner space, after the end of the movement of the plunger;
determining an abnormality in airtightness of the die casting mold using measurement result of the pressure of the inner space.
